(19) United States
(12) Patent Application Publication
(10) Pub. No.: US 2023/0235819 A1
(43) Pub. Date: Jul. 27, 2023

(54) VEHICLE CONTROL SYSTEM

(71) Applicant: Honda Motor Co., Ltd., Tokyo (JP)

(72) Inventors: Yurina MORIMOTO, Tokyo (JP); Taichi KITAMURA, Tokyo (JP); Shinichiro WATANABE, Tokyo (JP); Toshimi KANEKO, Tokyo (JP)

(73) Assignee: Honda Motor Co., Ltd., Tokyo (JP)

(21) Appl. No.: 18/156,356

(22) Filed: Jan. 18, 2023

(30) Foreign Application Priority Data
Jan. 25, 2022 (CN) 202210089659.3

(51) Int. Cl. F16H 61/16; B60R 22/48; B60Q 9/00; F16H 59/44; F16H 59/54; F16H 59/50

(52) U.S. Cl. CPC F16H 61/16; B60Q 9/00; B60R 22/48; F16H 59/44; F16H 59/50; F16H 59/54; B60R 2022/4883

(57) ABSTRACT

A vehicle control system is provided. The vehicle control system includes a shift-by-wire device for shifting a shift gear of a speed variator mounted in a vehicle according to a requirement of an electrical signal; a vehicle speed detecting member for detecting a vehicle speed of the vehicle; a seat belt detecting member for detecting whether a seat belt provided in the vehicle is fastened or taken off; a door open/close member for detecting whether a door provided in the vehicle is opened or closed; a presence detecting member for detecting a presence state of a passenger in the vehicle; and an automatic parking control device for controlling the shift-by-wire device to shift the shift gear to a park gear when output results of one of the door open/close member and the presence detecting member, the vehicle speed detecting member, and the seat belt detecting member satisfy predetermined conditions.

### CROSS-REFERENCE TO RELATED APPLICATION

This application claims the priority benefit of China application serial no. 202210089659.3, filed on Jan. 25, 2022. The entirety of the above-mentioned patent application is hereby incorporated by reference herein and made a part of this specification.

### BACKGROUND

### Technical Field

The disclosure relates to a vehicle control system.

### Description of Related Art

In the prior art, as a vehicle control system with an automatic parking mechanism, an automatic parking control device may be provided to perform automatic parking according to specified conditions, that is, automatically shift a shift gear (including a park gear P, a reverse gear R, a neutral gear N, or a drive gear D) of a speed variator to the park gear P. For example, when the driver seat belt is taken off, the door on the driver side is opened, and the driver leaves the driver seat, the vehicle control system determines that the driver is ready to get off the vehicle, and the automatic parking control device automatically shifts the shift gear to the park gear P.

However, using a door open/close member for detecting whether the door on the driver side is opened as one of the determining conditions may result in the issue that the shift gear cannot be shifted to the park gear P when the door open/close member fails. For example, when the closing of the door open/close member fails or the door open/close member is erroneously determined to be in the closed state, there is a possibility that the door opening cannot be determined when the door is opened. Therefore, there is a need for a vehicle control system applicable to various door open/close members to implement a convenient automatic parking mechanism regardless of whether the door open/close members fail.

### SUMMARY

The disclosure provides a vehicle control system, which includes a shift-by-wire device, configured to shift a shift gear of a speed variator mounted in a vehicle according to a requirement of an electrical signal; a vehicle speed detecting member, configured to detect a vehicle speed of the vehicle; a seat belt detecting member, configured to detect whether a seat belt provided in the vehicle is fastened or taken off; a door open/close member, configured to detect whether a door provided in the vehicle is opened or closed; a presence detecting member, configured to detect a presence state of a passenger in the vehicle; and an automatic parking control device, configured to control the shift-by-wire device to shift the shift gear to a park gear when output results of one of the door open/close member and the presence detecting member, the vehicle speed detecting member, and the seat belt detecting member satisfy predetermined conditions.

### BRIEF DESCRIPTION OF THE DRAWINGS

FIG. 1 is a schematic diagram of functional composition of a vehicle control system according to an embodiment of the disclosure.

FIG. 2 is a schematic timing diagram of a main operation flow of the vehicle control system shown in FIG. 1.

FIG. 3 is a schematic timing diagram of a main operation flow of the vehicle control system shown in FIG. 2 when a door open/close member is in an abnormal state.

FIG. 4 is a schematic timing diagram of an additional operation flow of the vehicle control system shown in FIG. 2.

FIG. 5 is a schematic timing diagram of another additional operation flow of the vehicle control system shown in FIG. 2.

### DETAILED DESCRIPTION OF DISCLOSED EMBODIMENTS

The disclosure provides a vehicle control system capable of implementing an automatic parking mechanism and improving convenience.

The disclosure provides a vehicle control system, which includes a shift-by-wire device, configured to shift a shift gear of a speed variator mounted in a vehicle according to a requirement of an electrical signal; a vehicle speed detecting member, configured to detect a vehicle speed of the vehicle; a seat belt detecting member, configured to detect whether a seat belt provided in the vehicle is fastened or taken off; a door open/close member, configured to detect whether a door provided in the vehicle is opened or closed; a presence detecting member, configured to detect a presence state of a passenger in the vehicle; and an automatic parking control device, configured to control the shift-by-wire device to shift the shift gear to a park gear when output results of one of the door open/close member and the presence detecting member, the vehicle speed detecting member, and the seat belt detecting member satisfy predetermined conditions.

In an embodiment of the disclosure, the predetermined conditions include detecting that the door is opened or not detecting presence of the passenger, detecting that the vehicle speed is below a predetermined value, and detecting that the seat belt is taken off.

In an embodiment of the disclosure, when the door open/close member is in an abnormal state, when detecting that the vehicle speed is below the predetermined value and the seat belt is taken off, and not detecting presence of the passenger, the automatic parking control device shifts the shift gear to the park gear.

In an embodiment of the disclosure, the vehicle control system further includes a brake pedal operable by a driver of the vehicle. When the shift gear is shifted to the park gear, when an operation amount of the brake pedal is above a predetermined value, the automatic parking control device shifts the shift gear from the park gear to another gear of the shift gear. The another gear includes a drive gear.

In an embodiment of the disclosure, when the shift gear is shifted from the park gear to the drive gear, when the operation amount of the brake pedal is reduced from above the predetermined value to below the predetermined value and the predetermined conditions are satisfied, the automatic parking control device shifts the shift gear to the park gear again.

In an embodiment of the disclosure, the vehicle control system further includes a notification portion for notifying the passenger. When the automatic parking control device shifts the shift gear to the park gear again, the notification portion notifies the passenger of information prompting the passenger to fasten the seat belt.

In an embodiment of the disclosure, when the automatic parking control device shifts the shift gear to the park gear again, when the operation amount of the brake pedal is above the predetermined value again, the notification portion does not notify.

In an embodiment of the disclosure, the vehicle control system further includes a brake pedal operable by a driver of the vehicle. When the shift gear is shifted to the park gear, when an operation amount of the brake pedal is below a predetermined value, the automatic parking control device does not shift the shift gear.

Based on the above, in the vehicle control system of the disclosure, when the output results of one of the door open/close member and the presence detecting member, the vehicle speed detecting member, and the seat belt detecting member satisfy the predetermined conditions, the automatic parking control device controls the shift-by-wire device to shift the shift gear to the park gear. In this way, using the output results of the door open/close member and the presence detecting member as an either-or determining condition, even if the door open/close member fails, the vehicle control system can still use the output results of the presence detecting member (the presence state of the passenger), the vehicle speed detecting member (the vehicle speed), and the seat belt detecting member (whether the seat belt is fastened or taken off) as determining conditions for automatic parking (that is, to automatically shift the shift gear to the park gear), which can prevent the door from being opened without automatic parking, so as to improve the convenience of the automatic parking mechanism. Accordingly, the vehicle control system of the disclosure can implement the automatic parking mechanism and improve convenience.

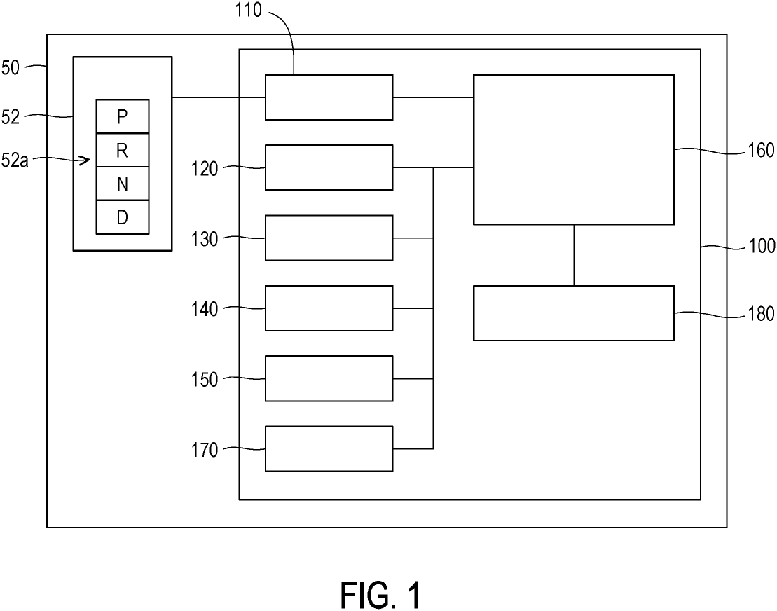

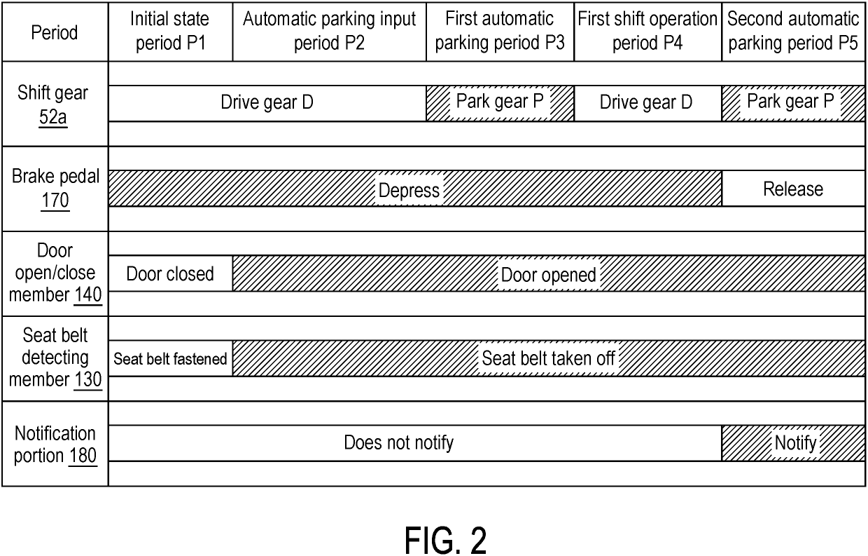

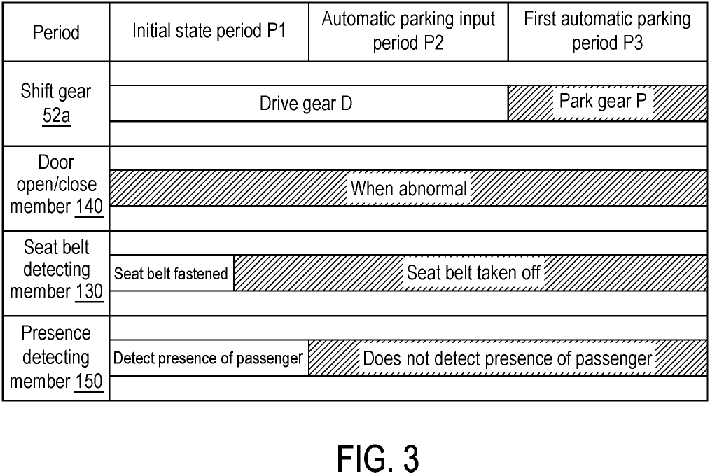

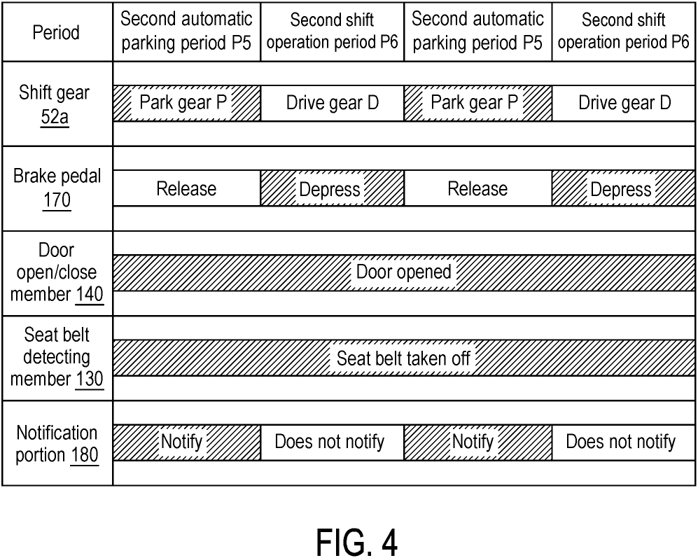

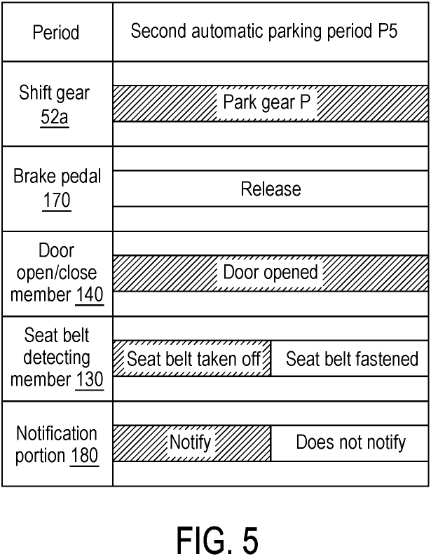

Reference will now be made in detail to the exemplary embodiments of the disclosure, examples of which are illustrated in the drawings. FIG. 1 is a schematic diagram of functional composition of a vehicle control system according to an embodiment of the disclosure. FIG. 2 is a schematic timing diagram of a main operation flow of the vehicle control system shown in FIG. 1. FIG. 3 is a schematic timing diagram of a main operation flow of the vehicle control system shown in FIG. 2 when a door open/close member is in an abnormal state. FIG. 4 is a schematic timing diagram of an additional operation flow of the vehicle control system shown in FIG. 2. FIG. 5 is a schematic timing diagram of another additional operation flow of the vehicle control system shown in FIG. 2. The specific composition of a vehicle control system 100 and the operation flow of the vehicle control system 100 of the embodiment will be described below with reference to FIG. 1 to FIG. 5, but the disclosure is not limited thereto.

First, please refer to FIG. 1. In the embodiment, the vehicle control system 100 includes a shift-by-wire device 110, a vehicle speed detecting member 120, a seat belt detecting member 130, a door open/close member 140, a presence detecting member 150, and an automatic parking control device 160. The shift-by-wire device 110 shifts a shift gear 52a, such as a park gear P, a reverse gear R, a neutral gear N, or a drive gear D, of a speed variator 52 mounted in a vehicle 50 according to a requirement of an electrical signal. The vehicle speed detecting member 120 detects a vehicle speed of the vehicle 50. The seat belt detecting member 130 detects whether a seat belt (not shown) provided in the vehicle 50 is fastened or taken off. The door open/close member 140 detects whether a door (not shown) provided in the vehicle 50 is opened or closed. The presence detecting member 150 detects a presence state of a passenger (for example, a driver) in the vehicle 50. The automatic parking control device 160 controls the shift-by-wire device 110 to shift the shift gear 52a of the speed variator 52 to the park gear P when output results of one of the door open/close member 140 and the presence detecting member 150, the vehicle speed detecting member 120, and the seat belt detecting member 130 satisfy predetermined conditions.

In detail, in the embodiment, the vehicle speed detecting member 120 is, for example, a vehicle speed sensor, but may be other members capable of calculating the vehicle speed from the wheel speed and the number of rotations of the tire or the motor of the vehicle 50. The seat belt detecting member 130 and the presence detecting member 150 use, for example, an in-vehicle camera to detect whether the seat belt is fastened or taken off and to detect the presence state of the passenger (for example, the driver), but may also be other seat belt sensors installed on the seat belt seat to detect whether the seat belt is buckled or presence sensors installed on the seat to detect presence of the passenger. The door open/close member 140 may be used as a basis for determining whether the door is opened or closed while controlling the opening or closing of the door, but an additional sensor may also be adopted to detect whether the door is opened. The output results of the various members are transmitted to the automatic parking control device 160 in the form of electric signals. The automatic parking control device 160 transmits determining results to the shift-by-wire device 110 in the form of electric signals according to predetermined determining conditions, so as to control whether the shift-by-wire device 110 shifts the shift gear 52a to the park gear P, so as to implement automatic parking. However, the disclosure does not limit the specific structures of the various devices and various components, which may be adjusted according to requirements.

In the embodiment, the predetermined conditions include detecting that the door is opened or not detecting presence of the passenger, detecting that the vehicle speed is below a predetermined value, and detecting that the seat belt is taken off. In other words, when the door open/close member 140 detects that the door is opened or the presence detecting member 150 does not detect presence of the passenger, the vehicle speed detecting member 120 detects that the vehicle speed is below a predetermined value (for example, a very low speed state such as 2 km/h or a parked state of 0), and the seat belt detecting member 130 detects that the seat belt is taken off, it is assumed that the passenger (for example, the driver) is ready to get off (the door is opened or the seat is empty) or the passenger (for example, the driver) temporarily takes off the seat belt and leaves the seat to move in the vehicle during a traffic jam (regardless of whether the door is opened), so the automatic parking control device 160 controls the shift-by-wire device 110 to shift the shift gear 52a to the park gear P, so as to implement the automatic parking mechanism.

Furthermore, in the embodiment, the vehicle control system 100 further includes a brake pedal 170 operable by the driver of the vehicle 50. Depressing or releasing of the brake pedal 170 and an operation amount (for example, the degree of depression, the time of depression, etc.) of the brake pedal 170 can also be used as one of the determining conditions of the automatic parking mechanism for the automatic parking control device 160 to control the shift-by-wire device 110 to shift the shift gear 52a of the speed variator 52 to the park gear P, and are sufficient to determine whether to park the vehicle 50 according to whether the vehicle speed is reduced below the predetermined value (for example, a very low speed state such as 2 km/h or a parked state of 0. However, the disclosure is not limited thereto and may be adjusted according to requirements.

The main operation flow of the vehicle control system 100 will be described below with reference to FIG. 2 and FIG. 3. The schematic timing diagram shown in FIG. 2 is the main operation flow of the vehicle control system 100 when the door open/close member 140 is in a normal state, and the schematic timing diagram shown in FIG. 3 is the main operation flow of the vehicle control system 100 when the door open/close member 140 is in an abnormal state. In other words, the schematic timing diagrams shown in FIG. 2 and FIG. 3 are used to describe the operation with the output results of the door open/close member 140 and the presence detecting member 150 as the either-or determining condition of the automatic parking mechanism. Therefore, when the door open/close member 140 is in the normal state (that is, in the example of FIG. 2), the operation of the presence detecting member 150 may not be performed (that is, it is not necessary to detect whether the passenger is seated), and when the door open/close member 140 is in the abnormal state (that is, in the example of FIG. 3), the operation of the presence detecting member 150 is performed. Alternatively, when the door open/close member 140 is in the normal state (that is, in the example of FIG. 2), the door open/close member 140 and the presence detecting member 150 may perform detection at the same time, and one of the output results is selected as one of the determining conditions according to the requirement. In the schematic timing diagram of FIG. 2, the detection timing (not shown) of the presence detecting member 150 is the same as the detection timing of the door open/close member 140, so the detection timing may be substituted for each other. However, the disclosure is not limited thereto and may be adjusted according to requirements.

Referring to the schematic timing diagram shown in FIG. 2, as an example, in the embodiment, the main operation flow of the vehicle control system 100 includes an initial state period P1, an automatic parking input period P2, and a first automatic parking period P3, so as to describe the automatic parking mechanism of the vehicle control system 100 when the door open/close member 140 is in the normal state. However, the main operation flow of the vehicle control system 100 may also include a first shift operation period P4, a second automatic parking period P5, etc. The disclosure does not limit the presence or absence of the first shift operation period P4 and the second automatic parking period P5, as long as the vehicle control system 100 can implement at least one automatic parking (that is, from the initial state period P1 to the first automatic parking period P3), which may be adjusted according to requirements.

Specifically, in the embodiment, the vehicle control system 100 is first in the initial state period P1. The initial state period P1 refers to a general operation period during which the automatic parking mechanism has not been performed. Therefore, during the initial state period P1, the shift gear 52a shown in FIG. 1 is at the drive gear D (may be at another gear (for example, the reverse gear R or the neutral gear N) other than the park gear P, and the disclosure is not limited thereto), the door open/close member 140 detects that the door is closed or the presence detecting member 150 detects presence of the passenger (the example of FIG. 2 is exemplified by the door open/close member 140 detecting that the door is closed, and the seat belt detecting member 130 detects that the seat belt is fastened. In addition, although not shown in FIG. 2, the vehicle speed detecting member 120 may detect the vehicle speed according to a preset condition or a preset period and may also detect the vehicle speed at any time to generate the output result, and the disclosure is not limited thereto.

In addition, during the initial state period P1, the shift gear 52a shown in FIG. 1 is at the drive gear D, so the vehicle 50 may be in a moving state (for example, the driver depresses an accelerator pedal not shown) or may also be in a deceleration state or a parked state (for example, the driver depresses the brake pedal 170). The brake pedal 170 being in a depressed state is equivalent to the moving vehicle 50 starting to decelerate, the decelerating vehicle 50 continuing to decelerate, or the parked vehicle 50 maintaining the parked state. At this time, when the door open/close member 140 detects that the door is opened or the presence detecting member 150 does not detect presence of the passenger (the example of FIG. 2 is exemplified by the door open/close member 140 detecting that the door is opened), the vehicle speed detecting member 120 detects that the vehicle speed is below the predetermined value (for example, a very low speed state such as 2 km/h or a parked state of 0), and the seat belt detecting member 130 detects that the seat belt is taken off, it is assumed that the passenger (for example, the driver) is ready to get off (the door is opened or the seat is empty) or the passenger (for example, the driver) temporarily takes off the seat belt and leaves the seat to move in the vehicle during a traffic jam (regardless of whether the door is opened), so the vehicle control system 100 enters the automatic parking input period P2 from the initial state period P1.

Next, in the embodiment, the automatic parking input period P2 refers to a period during which the vehicle control system 100 starts to execute but has not yet implemented the automatic parking mechanism. During the automatic parking input period P2, the door open/close member 140 detects that the door is opened or the presence detecting member 150 does not detect presence of the passenger (the example of FIG. 2 is exemplified by the door open/close member 140 detecting that the door is opened), the vehicle speed detecting member 120 detects that the vehicle speed is below the predetermined value (for example, a very low speed state such as 2 km/h or a parked state of 0), and the seat belt detecting member 130 detects that the seat belt is taken off. When the predetermined conditions are satisfied, even if the driver does not perform a shift operation (for example, operate a shift lever or a paddle shifter) to shift the shift gear 52a to the park gear P, the automatic parking control device 160 can still control the shift-by-wire device 110 to shift the shift gear 52a to the park gear P. Thereby, the vehicle control system 100 enters the first automatic parking period P3 from the automatic parking input period P2.

Furthermore, in the embodiment, the first automatic parking period P3 refers to a period during which the vehicle control system 100 actually performs the automatic parking mechanism for the first time. During the first automatic parking period P3, the shift gear 52a shown in FIG. 1 is shifted to the park gear P by the shift-by-wire device 110, the brake pedal 170 is maintained in the depressed state, the door open/close member 140 maintains detecting that the door is opened or the presence detecting member 150 maintains detecting presence of the passenger (the example of FIG. 2 is exemplified by the door open/close member 140 maintaining detecting that the door is opened), and the seat belt detecting member 130 maintains detecting that the seat belt is taken off. Thus, the vehicle control system 100 implements the first automatic parking mechanism.

After the first automatic parking period P3, if the driver leaves the driver seat or the driver releases the brake pedal 170, it is assumed that the passenger (for example, the driver) is ready to get off the vehicle (the door is opened or the seat is empty) or the passenger (for example, the driver) temporarily takes off the seat belt and leaves the seat to move in the vehicle during a traffic jam (regardless of whether the door is opened), so the automatic parking mechanism of the vehicle control system 100 ends according to the requirement, and the first shift operation period P4 and the second automatic parking period P5 as shown in FIG. 2 are not performed, so the shift gear 52a is maintained at the park gear P. In addition, after the first automatic parking period P3, if the driver does not leave the driver seat or the driver continues to depress the brake pedal 170, it is assumed that the driver still intends to operate the vehicle 50, so other operations can be performed subsequently (the first shift operation period P4 and the second automatic parking period P5 as shown in FIG. 2). The first shift operation period P4 and the second automatic parking period P5 are as described later.

Correspondingly, referring to the schematic timing diagram shown in FIG. 3, as an example, in the embodiment, the main operation flow of the vehicle control system 100 includes the initial state period P1, the automatic parking input period P2, and the first automatic parking period P3, so as to describe the automatic parking mechanism of the vehicle control system 100 when the door open/close member 140 is in the abnormal state. In other words, the schematic timing diagrams shown in FIG. 2 and FIG. 3 are performed depending on whether the state of the door open/close member 140 is normal or abnormal, but the disclosure does not exclude simultaneously performing the detection of the door open/close member 140 and the presence detecting member 150 when the door open/close member 140 is in the normal state, which may be adjusted according to requirements.

Specifically, in the embodiment, the vehicle control system 100 is first in the initial state period P1. When the door open/close member 140 is in the abnormal state (that is, in the example of FIG. 3), during the initial state period P1, the shift gear 52a shown in FIG. 1 is at the drive gear D (or may also be at the reverse gear R or the neutral gear N), the seat belt detecting member 130 detects that the seat belt is fastened, but the door open/close member 140 cannot detect whether the door is closed or opened, so the presence detecting member 150 detects presence of the passenger instead. In addition, although not shown in FIG. 3, the vehicle speed detecting member 120 may detect the vehicle speed according to a preset condition or a preset period and may also detect the vehicle speed at any time to generate the output result, and the disclosure is not limited thereto. In addition, the brake pedal 170 may be in the depressed state as shown in FIG. 2, but the disclosure is not limited thereto.

In addition, during the initial state period P1, when the door open/close member 140 is in the abnormal state, even if the seat belt detecting member 130 detects that the seat belt is taken off, the automatic parking mechanism is not yet triggered, and the presence detecting member 150 needs to perform subsequent detection (that is, to detect presence of the passenger) before the automatic parking mechanism can be triggered. In other words, when the door open/close member 140 is in the abnormal state (that is, in the example of FIG. 3), when the presence detecting member 150 does not detect presence of the passenger (equivalent to the passenger such as the driver having left the driver seat), the vehicle speed detecting member 120 detects that the vehicle speed is below the predetermined value (for example, a very low speed state such as 2 km/h or a parked state of 0), and the seat belt detecting member 130 detects that the seat belt is taken off, it is assumed that the passenger (for example, the driver) is ready to get off the vehicle (the door is opened or the seat is empty) or the passenger (for example, the driver) temporarily takes off the seat belt and leaves the seat to move in the vehicle during a traffic jam (regardless of whether the door is opened), so the vehicle control system 100 enters the automatic parking input period P2 from the initial state period P1.

Next, in the embodiment, during the automatic parking input period P2, when the door open/close member 140 is in the abnormal state, when detecting that the vehicle speed is below the predetermined value (for example, a very low speed state such as 2 km/h or a parked state of 0) and the seat belt is taken off, and not detecting presence of the passenger, the automatic parking control device 160 controls the shift-by-wire device 110 to shift the shift gear 52a to the park gear P. In other words, when the door open/close member 140 is in the abnormal state, when the predetermined conditions of the presence detecting member 150 not detecting presence of the passenger, the vehicle speed detecting member 120 detecting that the vehicle speed is below the predetermined value, and the seat belt detecting member 130 detecting that the seat belt is taken off are satisfied, even if the driver does not perform the shift operation (for example, operate a shift lever or a paddle shifter) to shift the shift gear 52a to the park gear P, the automatic parking control device 160 can still control the shift-by-wire device 110 to shift the shift gear 52a to the park gear P. Thereby, the vehicle control system 100 enters the first automatic parking period P3 from the automatic parking input period P2.

Furthermore, in the embodiment, during the first automatic parking period P3, the shift gear 52a shown in FIG. 1 is shifted to the park gear P by the shift-by-wire device 110, the brake pedal 170 is maintained in the depressed state (refer to FIG. 2), the presence detecting member 150 maintains not detecting presence of the passenger, and the seat belt detecting member 130 maintains detecting that the seat belt is taken off. Thus, the vehicle control system 100 implements the first automatic parking mechanism.

After the first automatic parking period P3, since the presence detecting member 150 maintains not detecting presence of the passenger, it is assumed that the driver leaves the driver seat or the driver releases the brake pedal 170, that is, it is assumed that the passenger (for example, the driver) is ready to get off the vehicle (the door is opened or the seat is empty) or the passenger (for example, the driver) temporarily takes off the seat belt and leaves the seat to move in the vehicle during a traffic jam (regardless of whether the door is opened), so the vehicle control system 100 ends according to the requirement, and the first shift operation period P4 and the second automatic parking period P5 as shown in FIG. 2 are not performed, so the shift gear 52a is maintained at the park gear P.

In addition, in the schematic timing diagram shown in FIG. 3, although it is assumed that the driver leaves the driver seat or the driver releases the brake pedal 170, if the driver still intends to operate the vehicle 50, the driver may also subsequently perform other operations (the first shift operation period P4 and the second automatic parking period P5 as shown in FIG. 2) according to other determining conditions. In other words, in the state of FIG. 3, it is not excluded to execute the first shift operation period P4 and the second automatic parking period P5 shown in FIG. 2 after the first automatic parking period P3, and the disclosure is not limited thereto.

In this way, comparing the schematic timing diagrams shown in FIG. 2 and FIG. 3, using the output results of the door open/close member 140 and the presence detecting member 150 as the either-or determining condition, even if the door open/close member 140 fails, the vehicle control system 100 can still use the output results of the presence detecting member 150 (the presence state of the passenger), the vehicle speed detecting member 120 (the vehicle speed), and the seat belt detecting member 130 (whether the seat belt is fastened or taken off) as the determining conditions for automatic parking (that is, to automatically shift the shift gear 52a to the park gear P), which can prevent the door from being opened without automatic parking, so as to improve the convenience of the automatic parking mechanism. In other words, the vehicle control system 100 can select to execute which of the schematic timing diagrams shown in FIG. 2 and FIG. 3 according to whether the door open/close member 140 is normal or abnormal (but not limited thereto, when the door open/close member 140 is in the normal state, the schematic timing diagram shown in FIG. 3 may also be selected to select the output result of the presence detecting member 150). Accordingly, the vehicle control system 100 can implement the automatic parking mechanism and improve convenience.

Furthermore, in the embodiment, as shown in FIG. 2, after the first automatic parking period P3, if the driver does not leave the driver seat or if the driver continues to depress the brake pedal 170, it is assumed that the driver still intends to drive the vehicle 50, so other operations can also be performed subsequently, such as the first shift operation period P4 and the second automatic parking period P5 in the schematic timing diagram shown in FIG. 2. However, when the shift gear 52a shown in FIG. 1 is shifted to the park gear P (that is, during the first automatic parking period P3), when the operation amount of the brake pedal 170 is above the predetermined value (equivalent to when the driver intends to operate the vehicle 50), the automatic parking control device 160 shifts the shift gear 52a from the park gear P to another gear, such as the drive gear D (or another gear (for example, the reverse gear R or the neutral gear N) other than the park gear P, and the disclosure is not limited thereto), of the shift gear 52a, so as to enter the first shift operation period P4 from the first automatic parking period P3. In other words, during the first automatic parking period P3, when the operation amount of the brake pedal 170 is above the predetermined value, it is assumed that the driver intends to operate the vehicle 50, so the shift operation (that is, to shift the shift gear 52a from the park gear P to the drive gear D) is performed.

Therefore, in the embodiment, during the first automatic parking period P3, even if the shift gear 52a is shifted to the park gear P by the automatic parking control device 160, the shift gear 52a may still be shifted from the park gear P to another gear (for example, the drive gear D) in response to the operation amount of the brake pedal 170, so as to enter the first shift operation period P4. At this time, during the first shift operation period P4, the shift gear 52a shown in FIG. 1 is shifted to another gear (for example, the drive gear D) by the shift-by-wire device 110, the brake pedal 170 is maintained in the depressed state, the door open/close member 140 maintains detecting that the door is opened or the presence detecting member 150 maintains detecting presence of the passenger (the example of FIG. 2 is exemplified by the door open/close member 140 maintaining detecting that the door is opened), and the seat belt detecting member 130 maintains detecting that the seat belt is taken off. At this time, the vehicle speed detecting member 120 may select whether to perform detection according to the requirement, and the disclosure is not limited thereto.

Correspondingly, when the shift gear 52a shown in FIG. 1 is shifted to the park gear P (that is, during the first automatic parking period P3), when the operation amount of the brake pedal 170 is below the predetermined value, the automatic parking control device 160 does not shift the shift gear 52a (that is, does not enter the first shift operation period P4). In other words, after the first automatic parking period P3, if the driver leaves the driver seat or the driver does not continue to depress the brake pedal 170, it is assumed that the driver does not intend to continue operating the vehicle 50, so the automatic parking control device 160 does not shift the shift gear 52a (does not perform the first shift operation period P4 as shown in FIG. 2), and the shift gear 52a is still at the park gear P without being shifted to another gear such as the drive gear D. Thereby, after the shift gear 52a is shifted to the park gear P by the automatic parking control device 160, when the driver releases the brake pedal 170, even if the driver performs a misoperation, the vehicle 50 can still be suppressed from moving forward or reverse. Only when the operation amount of the brake pedal 170 is above the predetermined value (equivalent to when the driver intends to operate the vehicle 50), the shift gear 52a is shifted to the drive gear D (to enter the first shift operation period P4), so as to improve convenience.

Furthermore, please return to the schematic timing diagram shown in FIG. 2 again. In the embodiment, when the shift gear 52a is shifted from the park gear P to the drive gear D (that is, during the first shift operation period P4), when the operation amount of the brake pedal 170 is reduced from above the predetermined value to below the predetermined value and the predetermined condition is satisfied, the automatic parking control device 160 shifts the shift gear 52a to the park gear P again, so as to enter the second automatic parking period P5 from the first shift operation period P4.

In other words, in the embodiment, during the first shift operation period P4, when the driver releases the brake pedal 170 to reduce the operation amount of the brake pedal 170 to below the predetermined value, the door open/close member 140 detects that the door is opened or the presence detecting member 150 does not detect presence of the passenger (the example of FIG. 2 is exemplified by the door open/close member 140 detecting that the door is opened), the vehicle speed detecting member 120 detects that the vehicle speed is below the predetermined value, and the seat belt detecting member 130 detects that the seat belt is taken off, it is assumed that the passenger (for example, the driver) is ready to get off the vehicle (the door is opened or the seat is empty) or the passenger (for example, the driver) temporarily removes the seat belt and leaves the seat to move in the vehicle during a traffic jam (regardless of whether the door is opened), the automatic parking control device 160 controls the shift-by-wire device 110 to shift the shift gear 52a to the park gear P, so as to implement the automatic parking mechanism.

Therefore, in the embodiment, during the first shift operation period P4, after the shift gear 52a is shifted to the drive gear D by the automatic parking control device 160, even if the driver forgets to shift the shift gear 52a to the park gear P or the driver cancels the park gear P due to misoperation, the shift gear 52a may still be shifted to the park gear P again in response to the operation amount of the brake pedal 170, so as to enter the second automatic parking period P5. At this time, during the second automatic parking period P5, the shift gear 52a shown in FIG. 1 is shifted to the park gear P by the shift-by-wire device 110, the brake pedal 170 is maintained in a released state, the door open/close member 140 maintains detecting that the door is opened or the presence detecting member 150 maintains detecting presence of the passenger (the example of FIG. 2 is exemplified by the door open/close member 140 maintaining detecting that the door is opened), and the seat belt detecting member 130 maintains detecting that the seat belt is taken off.

Furthermore, in the embodiment, as shown in FIG. 1, the vehicle control system 100 further includes a notification portion 180 for notifying the passenger. Therefore, when the automatic parking control device 160 shifts the shift gear 52a to the park gear P again (that is, during the second automatic parking period P5), as shown in FIG. 2, the notification portion 180 notifies the passenger of information prompting the passenger to fasten the seat belt. The notification portion 180 is, for example, a display panel that displays texts or images, a light-emitting element that can turn on and off lights, or a player that plays audio, or the notification portion 180 may not be used, and the disclosure is not limited thereto. In other words, during the second automatic parking period P5 as shown in FIG. 2, it is assumed that the driver may intend to subsequently perform an operation (for example, to perform the shift operation again, etc.) of the vehicle 50. Therefore, the notification portion 180 is preferred to not notify the passenger from the initial state period P1 to the first shift operation period P4, and during the second automatic parking period P5, the notification portion 180 notifies the passenger of information prompting the passenger to fasten the seat belt, and the passenger may further fasten the seat belt according to the notification of the notification portion 180 after being seated and closing the door,.

In addition, in the embodiment, as shown in the schematic timing diagram of the additional operation flow of the vehicle control system 100 as shown in FIG. 4, when the automatic parking control device 160 shifts the shift gear 52a to the park gear P again (that is, during the second automatic parking period P5), when the operation amount of the brake pedal 170 is above the predetermined value again (equivalent to the driver depressing the brake pedal 170 when intending to operate the vehicle 50), the automatic parking control device 160 shifts the shift gear 52a from the park gear P to another gear (for example, the drive gear D) of the shift gear 52a again, so as to enter a second shift operation period P6 from the second automatic parking period P5.

In other words, during the second automatic parking period P5, when the predetermined conditions (detecting that the door is opened or not detecting presence of the passenger, detecting that the vehicle speed is below the predetermined value, and detecting that the seat belt is taken off) are satisfied, when the operation amount of the brake pedal 170 is above the predetermined value again, it is assumed that the driver intends to operate the vehicle 50 again, so the shift operation (that is, to shift the shift gear 52a from the park gear P to the drive gear D) is performed again. Accordingly, during the second automatic parking period P5, even if the shift gear 52a is shifted to the park gear P by the automatic parking control device 160, the shift gear 52a may still be shifted from the park gear P to another gear (for example, the drive gear D) in response to the operation amount of the brake pedal 170, so as to enter the second shift operation period P6.

Furthermore, in the embodiment, during the second automatic parking period P5, the notification portion 180 has notified the passenger of the information prompting the passenger to fasten the seat belt. Therefore, when the automatic parking control device 160 shifts the shift gear 52a to the park gear P again, when the operation amount of the brake pedal 170 is above the predetermined value again (that is, during the second shift operation period P6), the notification portion 180 does not notify. In other words, when the driver depresses the brake pedal 170 and intends to perform the shift operation again (that is, to shift the shift gear 52a from the park gear P to the drive gear D to enter the second shift operation period P6), it is assumed that the driver is aware of the subsequent need to fasten the seat belt, so there is no need to notify again. As a result, the notification portion 180 does not perform unnecessary notification, which can reduce the trouble caused by frequent notifications to the passenger. However, in other embodiments not shown, the notification may be always performed or the notification portion 180 may not be provided, and the disclosure is not limited thereto.

In addition, in the embodiment, during the second shift operation period P6, when the predetermined conditions (detecting that the door is opened or not detecting presence of the passenger, detecting that the vehicle speed is below the predetermined value, and detecting that the seat belt is taken off) are satisfied, the automatic parking control device 160 may control the shift-by-wire device 110 to repeatedly automatically shift the shift gear 52a between the park gear P and the drive gear D in response to the operation amount of the brake pedal 170. In other words, after the first automatic parking period P3 and the first shift operation period P4 shown in FIG. 2, the vehicle control system 100 can not only shift the shift gear 52a according to the foregoing manner to enter the second automatic parking period P5 and the second shift operation period P6 shown in FIG. 4, but also repeatedly perform the second automatic parking period P5 and the second shift operation period P6 according to the requirement to repeatedly automatically shift the shift gear 52a between the park gear P and the drive gear D. However, in other embodiments not shown, the vehicle control system 100 may also have only one second automatic parking period P5 and second shift operation period P6 or no second automatic parking period P5 and second shift operation period P6, and the disclosure is not limited thereto.

In addition, in the schematic timing diagram shown in FIG. 4, during the second automatic parking period P5, the notification portion 180 notifies (that is, notifies the passenger of information prompting the passenger to fasten the seat belt), and during the second shift operation period P6, the notification portion 180 does not notify. Therefore, when the vehicle control system 100 repeatedly performs the second automatic parking period P5 and the second shift operation period P6 according to the requirement, the notification portion 180 may also repeatedly notify or not notify in response to the determination condition (for example, depressing or releasing of the brake pedal 170). However, the disclosure does not limit the notification timing of the notification portion 180, which may be adjusted according to requirements.

Correspondingly, in the embodiment, in the sequence diagram of another additional operation flow of the vehicle control system 100 shown in FIG. 5, when the automatic parking control device 160 shifts the shift gear 52a to the park gear P again (that is, during the second automatic parking period P5), when the operation amount of the brake pedal 170 is maintained below the predetermined value (that is, the brake pedal 170 is in the released state), if the seat belt detecting member 130 detects that the seat belt is fastened, the predetermined conditions (detecting that the door is opened or not detecting presence of the passenger, detecting that the vehicle speed is below the predetermined value, and detecting that the seat belt is taken off) are not satisfied, so the shift operation is performed, that is, the second shift operation period P6 for shifting the shift gear 52a from the park gear P to the drive gear D is not entered. At this time, since the seat belt detecting member 130 detects that the seat belt is fastened, the notification portion 180 may cancel the notification (that is, not notify) in response to the time point when the seat belt is fastened. As a result, the notification portion 180 does not perform unnecessary notification, which can reduce the trouble caused by frequent notifications to the passenger.

In summary, in the vehicle control system of the disclosure, when the output results of one of the door open/close member and the presence detecting member, the vehicle speed detecting member, and the seat belt detecting member satisfy the predetermined conditions, the automatic parking control device controls the shift-by-wire device to shift the shift gear to the park gear. Preferably, the predetermined conditions include detecting that the door is opened or not detecting presence of the passenger, detecting that the vehicle speed is below the predetermined value, and detecting that the seat belt is taken off. In this way, using the output results of the door open/close member and the presence detecting member as the either-or determining condition, even if the door open/close member fails, the vehicle control system can still use the output results of the presence detecting member (the presence state of the passenger), the vehicle speed detecting member (the vehicle speed), and the seat belt detecting member (whether the seat belt is fastened or taken off) as the determining conditions for automatic parking (that is, to automatically shift the shift gear to the park gear), which can prevent the door from being opened without automatic parking, so as to improve the convenience of the automatic parking mechanism. Accordingly, the vehicle control system of the disclosure can implement the automatic parking mechanism and improve convenience.

Finally, it should be noted that the above embodiments are only used to illustrate, but not to limit, the technical solutions of the disclosure. Although the disclosure is described in detail with reference to the above embodiments, persons skilled in the art should understand that the technical solutions described in the above embodiments can still be modified or some or all of the technical features thereof can be equivalently replaced. However, the modifications or replacements do not cause the essence of the corresponding technical solutions to deviate from the scope of the technical solutions of the embodiments of the disclosure.

What is claimed is:

1. A vehicle control system, comprising:
a shift-by-wire device, configured to shift a shift gear of a speed variator mounted in a vehicle according to a requirement of an electrical signal;
a vehicle speed detecting member, configured to detect a vehicle speed of the vehicle;
a seat belt detecting member, configured to detect whether a seat belt provided in the vehicle is fastened or taken off;
a door open/close member, configured to detect whether a door provided in the vehicle is opened or closed;
a presence detecting member, configured to detect a presence state of a passenger in the vehicle; and
an automatic parking control device, configured to control the shift-by-wire device to shift the shift gear to a park gear when output results of one of the door open/close member and the presence detecting member, the vehicle speed detecting member, and the seat belt detecting member satisfy predetermined conditions.

2. The vehicle control system according to claim 1, wherein:
the predetermined conditions comprise detecting that the door is opened or not detecting presence of the passenger, detecting that the vehicle speed is below a predetermined value, and detecting that the seat belt is taken off.

3. The vehicle control system according to claim 1, wherein:
when the door open/close member is in an abnormal state, when detecting that the vehicle speed is below a predetermined value and the seat belt is taken off, and not detecting presence of the passenger, the automatic parking control device shifts the shift gear to the park gear.

4. The vehicle control system according to claim 1, further comprising a brake pedal operable by a driver of the vehicle, wherein:
when the shift gear is shifted to the park gear, when an operation amount of the brake pedal is above a predetermined value, the automatic parking control device shifts the shift gear from the park gear to another gear of the shift gear, and the another gear comprises a drive gear.

5. The vehicle control system according to claim 1, further comprising a brake pedal operable by a driver of the vehicle, wherein:
when the shift gear is shifted to the park gear, when an operation amount of the brake pedal is below a predetermined value, the automatic parking control device does not shift the shift gear.

6. The vehicle control system according to claim 2, wherein:
when the door open/close member is in an abnormal state, when detecting that the vehicle speed is below the predetermined value and the seat belt is taken off, and not detecting presence of the passenger, the automatic parking control device shifts the shift gear to the park gear.

7. The vehicle control system according to claim 2, further comprising a brake pedal operable by a driver of the vehicle, wherein:
when the shift gear is shifted to the park gear, when an operation amount of the brake pedal is above a predetermined value, the automatic parking control device shifts the shift gear from the park gear to another gear of the shift gear, and the another gear comprises a drive gear.

8. The vehicle control system according to claim 2, further comprising a brake pedal operable by a driver of the vehicle, wherein:
when the shift gear is shifted to the park gear, when an operation amount of the brake pedal is below a predetermined value, the automatic parking control device does not shift the shift gear.

9. The vehicle control system according to claim 4, wherein:
when the shift gear is shifted from the park gear to the drive gear, when the operation amount of the brake pedal is reduced from above the predetermined value to below the predetermined value and the predetermined conditions are satisfied, the automatic parking control device shifts the shift gear to the park gear again.

10. The vehicle control system according to claim 7, wherein:
when the shift gear is shifted from the park gear to the drive gear, when the operation amount of the brake pedal is reduced from above the predetermined value to below the predetermined value and the predetermined conditions are satisfied, the automatic parking control device shifts the shift gear to the park gear again.

11. The vehicle control system according to claim 9, further comprising a notification portion for notifying the passenger, wherein:
when the automatic parking control device shifts the shift gear to the park gear again, the notification portion notifies the passenger of information prompting the passenger to fasten the seat belt.

12. The vehicle control system according to claim 10, further comprising a notification portion for notifying the passenger, wherein:
when the automatic parking control device shifts the shift gear to the park gear again, the notification portion notifies the passenger of information prompting the passenger to fasten the seat belt.

13. The vehicle control system according to claim 11, wherein:
when the automatic parking control device shifts the shift gear to the park gear again, when the operation amount of the brake pedal is above the predetermined value again, the notification portion does not notify.

14. The vehicle control system according to claim 12, wherein:
when the automatic parking control device shifts the shift gear to the park gear again, when the operation amount of the brake pedal is above the predetermined value again, the notification portion does not notify.
